(19) United States
(12) Patent Application Publication
(10) Pub. No.: US 2022/0274868 A1
(43) Pub. Date: Sep. 1, 2022

(54) MANUFACTURING METHOD FOR CHEMICALLY STRENGTHENED GLASS

(71) Applicant: AGC INC., Tokyo (JP)

(72) Inventors: Kaname SEKIYA, Tokyo (JP); Izuru KASHIMA, Tokyo (JP); Hiroki TAKAHASHI, Tokyo (JP)

(73) Assignee: AGC INC., Tokyo (JP)

(21) Appl. No.: 17/652,553

(22) Filed: Feb. 25, 2022

(30) Foreign Application Priority Data
Feb. 26, 2021 (JP) 2021-030727

(51) Int. Cl. C03C 21/00; C03C 3/083

(52) U.S. Cl. CPC C03C 21/002; C03C 3/083; C03C 2203/50

(57) ABSTRACT

The present invention relates to a manufacturing method for a chemically strengthened glass, the method including: performing a first ion exchange by immersing a glass for chemical strengthening containing first alkali metal ions in a first molten salt composition containing second alkali metal ions; after the first ion exchange, performing a second ion exchange by immersing the chemically strengthened glass obtained after the first ion exchange in a second molten salt composition containing the first metal ions and third alkali metal ions; continuously using the first molten salt composition after being used for the first ion exchange; and continuously using a second molten salt composition after being used for the second ion exchange, in which: a concentration of the second molten salt composition is controlled by adding the first alkali metal ions to the second molten salt composition and a resulting second molten salt composition is used continuously.

### TECHNICAL FIELD

The present invention relates to a manufacturing method for a chemically strengthened glass.

### BACKGROUND ART

The chemically strengthened glass is used for cover glasses of portable terminals etc. The chemically strengthened glass is a glass in which a compressive stress layer is formed in a surface portion of the glass through an ion exchange between alkali metal ions contained in the glass and alkali metal ions having a larger ion radius contained in a molten salt composition by bringing glass into contact with the molten salt composition such as sodium nitrate.

The strength of the chemically strengthened glass depends strongly on a stress profile represented by the compressive stress (hereinafter also referred to as “CS”) with the depth from the glass surface as a variable. The cover glasses of portable terminals etc. may be broken by deforming when they are dropped etc. To prevent such breaking, that is, breaking due to bending, it is effective to increase the compressive stress near the glass surface.

On the other hand, the cover glasses of portable terminals etc. may also be broken by collision with a protrusion when they are dropped onto an asphalt surface or grit. To prevent such breaking, that is, breaking due to impact, it is effective to increase its strength by forming a compressive stress layer to a deeper potion of the glass by increasing the compressive stress layer depth.

However, when the compressive stress layer is formed in a surface portion of a glass article, a tensile stress (hereinafter also referred to as “CT”) necessarily occurs in a core portion of the glass article according to surface compressive stress. In the case where this tensile stress is too large, a glass article is broken violently to scatter fragments. If CT exceeds a threshold value (hereinafter referred to as a “CT limit”), the number of fragments at the time of breaking starts to increase explosively. Thus, in the chemically strengthened glass, whereas a compressive stress layer is formed to a deep portion by setting the surface compressive stress large, the total amount of compressive stress in a surface layer is determined so that the total amount of compressive stress in a surface layer does not become too large. For example, Patent document 1 discloses a chemically strengthened glass in which CT is controlled to a particular range.

Patent document 2 discloses, as a manufacturing method for a chemically strengthened glass having higher impact resistance, a strengthened glass manufacturing method for obtaining strengthened glass by subjecting a glass for strengthening containing first alkali metal ions to a ion exchange treatment, the method including a first ion exchange process of introducing second alkali metal ions into the glass for strengthening by bringing a first molten salt containing second alkali metal ions having a larger ion radius than the first alkali metal ions into contact with the glass for strengthening, and a second ion exchange process, executed after the first ion exchange process, of removing at least part of the second metal ions from the glass for strengthening and introducing third alkali metal ions into the glass for strengthening by bringing a second molten salt containing first alkali metal ions and third alkali metal ions having a larger ion radius than the second alkali metal ions into contact with the glass for strengthening.

Patent document 3 discloses a manufacturing method for a strengthened glass having a surface and a thickness T, including a first ion exchange process of introducing Na ions into a glass for strengthening by bringing the glass for strengthening containing Li₂O and Na₂O into contact with a first molten salt containing Na ions, and a second ion exchange process, executed after the first ion exchange process, of removing at least part of the Na ions from the glass for strengthening and introducing K ions into the glass for strengthening by bringing the glass for strengthening into contact with a second molten salt containing Li ions and K ions, in which the first ion exchange process and the second ion exchange process are executed so that a stress profile obtained by measuring stress in a depth direction from a surface with compressive stress expressed as a positive number and tensile stress expressed a negative number, respectively, has an inflection point where a second derivative of the stress profile is equal to zero between the surface to a point whose depth is half of the thickness T.

[Patent document 1] JP-T-2011-530470 (The symbol “JP-T” as used herein means a published Japanese translation of a PCT patent application.)

[Patent document 2] WO 2020/075708

[Patent document 3] WO 2020/075709

As described in Patent document 2 and Patent document 3, chemically strengthened glass having high strength, in which strong compressive stress is produced in the vicinity of the glass surface, can be manufactured by performing first ion exchange by bringing a first molten salt composition containing second alkali metal ions having a larger ion radius than first alkali metal ions into contact with glass for strengthening containing the first alkali metal ions and then performing second ion exchange by bringing a second molten salt composition containing first alkali metal ions and third alkali metal ions having a larger ion radius than the second alkali metal ions into contact with the glass for strengthening.

However, in the case where the above manufacturing method for chemically strengthened glass including the first ion exchange and the second ion exchange is applied to a manufacturing method for chemically strengthened glass that uses molten salt compositions repeatedly (hereinafter also referred to as “continuous use”), a problem arises that the compressive stress produced in the vicinity of the surface of chemically strengthened glass obtained lowers gradually.

### SUMMARY OF INVENTION

An object of the present invention is therefore to provide a manufacturing method for chemically strengthened glass capable of manufacturing chemically strengthened glass having high strength with higher efficiency than conventional manufacturing methods.

The present inventors have found that in the case where the molten salt compositions are used repeatedly in the above-described manufacturing method for chemically strengthened glass including the first ion exchange and the second ion exchange, the cumulative processed area of chemically strengthened glass obtained after the first ion exchange processed using the second molten salt composition increases and the compressive stress produced in the vicinity of the surface of the chemically strengthened glass manufactured thereby decreases gradually. The inventors have also found that the reduction of the compressive stress can be suppressed by continuing to use the second molten salt composition and adding first alkali metal ions to a second molten salt composition after being used for preceding second ion exchange. The inventors have completed the invention based on these pieces of knowledge.

A manufacturing method for a chemically strengthened glass, the method including: performing a first ion exchange by immersing a glass for chemical strengthening containing first alkali metal ions in a first molten salt composition containing second alkali metal ions having a larger ion radius than the first alkali metal ions;

performing a second ion exchange, after the first ion exchange, by immersing the chemically strengthened glass obtained after the first ion exchange in a second molten salt composition containing the first metal ions and third alkali metal ions having a larger ion radius than the second alkali metal ions;

continuously using a first molten salt composition after being used for the first ion exchange for a next first ion exchange; and

continuously using a second molten salt composition after being used for the second ion exchange for a next second ion exchange,

in which:

a concentration of the second molten salt composition is controlled by adding the first alkali metal ions to the second molten salt composition after being used for the second ion exchange to continuously use a resulting second molten salt composition for the next second ion exchange.

The manufacturing method for chemically strengthened glass according to the present invention can suppress the reduction of compressive stress in the vicinity of the surface of chemically strengthened glass manufactured due to deterioration of the second molten salt composition by continuing to use it and adding first alkali metal ions to a second molten salt composition after being used for second ion exchange in the above-described manufacturing method for chemically strengthened glass including the first ion exchange and the second ion exchange. In this manner, chemically strengthened glass having high strength with higher productivity can be manufactured than in conventional manufacturing methods.

### BRIEF DESCRIPTION OF DRAWINGS

FIGS. 1A and 1B illustrate respective example processes in which a molten salt composition is used repeatedly in a manufacturing method for chemically strengthened glass including a first ion exchange process and a second ion exchange process. FIG. 1A illustrates an example process of a conventional manufacturing method and FIG. 1B illustrates an example process of a manufacturing method according to an embodiment of the present invention.

FIG. 2 is a graph showing a stress profile of chemically strengthened glass manufactured by a manufacturing method according to an embodiment of the invention.

FIG. 3A is a graph showing a correlation between the cumulative processed area of chemically strengthened glass obtained after the first ion exchange processed using the second molten salt composition and the surface layer compressive stress value (CS₀) of the chemically strengthened glass manufactured.

FIG. 3B is a graph showing a correlation between the cumulative processed area and the compressive stress value (CS₅₀), at a depth 50 μm from the surface, of the chemically strengthened glass manufactured.

FIG. 4A is a graph showing a correlation between the cumulative processed area of chemically strengthened glass obtained after the first ion exchange processed using the second molten salt composition and the Li concentration in the second molten salt composition.

FIG. 4B is a graph showing a correlation between the cumulative processed area and the Na concentration in the second molten salt composition.

### DESCRIPTION OF EMBODIMENTS

In the present specification, the symbol “-” (or the word “to”) is used to express a numerical range including the numerical values written before and after it as a lower limit value and an upper limit value, respectively, unless otherwise specified. The expression “to add alkali metal ions” means adding intentionally a prescribed amount of an inorganic salt source containing alkali metal ions.

A stress profile can be measured by a method using a scattered light photoelastic stress meter (SLP). The scattered light photoelastic stress meter is a stress measurement device including a polarization phase difference variable member configured to vary a polarization phase difference of a laser light by one wavelength of the laser light or more, an imaging element configured to image a plurality of times at a predetermined time interval a scattered light emitted according to the laser light with the varied polarization phase difference entering the strengthened glass, and an arithmetic unit configured to measure a periodic change in luminance of the scattered light using the plurality of images, calculate a change in a phase of change in luminance, and calculate a stress distribution in a depth direction from a surface of the strengthened glass based on the change in the phase. (refer to WO 2018/056121).

A method using a scattered light photoelastic stress meter (SLP) can measure compressive stress originating from Li—Na exchange in a glass deep portion that is distant from the glass surface by several tens of micrometers or more. On the other hand, a method using a film stress measurement meter (FSM) can measure compressive stress originating from Na—K exchange in a glass surface layer that is distant from the glass surrace by several tens of micrometers or less (refer to WO 2018/056121 and WO 2017/115811, for example).

An example method for measuring a stress profile using a scattered light photoelastic stress meter is a method disclosed in WO 2018/056121. Examples of scattered light photoelastic stress meters are SLP-1000 and SLP-2000 produced by Orihara Industrial Co., Ltd. A highly accurate stress measurement can be performed by combining each of these scattered light photoelastic stress meter with software SlpIV (ver. 2019.01.10.001) attached to it.

In the present specification, the term “chemically strengthened glass” means glass that has been subjected to chemically strengthening treatment and the term “glass for chemical strengthening” means glass before being subjected to chemically strengthening treatment. In the present specification, the term “base composition of chemically strengthened glass” means a glass composition of glass for chemical strengthening and glass composition of a portion that is deeper than a compressive stress layer depth (hereinafter also abbreviated as “DOLzero”) of chemically strengthened glass is approximately the same as in the base composition of the chemically strengthened glass except for a case that an extreme ion exchange process was executed. In the present specification, a glass composition is expressed in mol % based on oxides unless otherwise specified and mol % may be written simply as “%.”

### <Manufacturing Method for Chemically Strengthened Glass>

When a glass article is dropped onto an asphalt-paved road or grit, a crack may develop due to collision with a protrusion such as a grit object. Whereas the length of the crack depends on the size of the protrusion, the glass article can be prevented from breaking into fragments even when it collides with a relatively large protrusion because of a stress profile in which a large compressive stress at the portion around the depth 50 μm, for example, is formed if a compressive stress value CS₅₀ (MPa) at a depth of 50 μm from the glass surface is set large. As such, the CS₅₀ value closely contributes to the resistance to fracture due to drop impact. That is, to increase the resistance to fracture due to drop impact, how to increase CS50 is an important issue.

A stress value CS₉₀ (MPa) at a depth 90 μm also contributes to the resistance to fracture due to drop impact. That is, if a compressive stress value CS₉₀ at a depth of 90 μm from the glass surface, measured by a scattered light photoelastic stress meter, is set large, a stress profile, in which a large compressive stress at the portion around the depth 90 μm, for example, is formed, is obtained, whereby a glass article can be prevented from breaking into fragments even when it collides with a relatively large protrusion.

The chemically strengthening treatment is treatment of replacing metal ions having a small ion radius (typically, lithium ions or sodium ions) in glass with metal ions having a large ion radius (typically, sodium ions or potassium ions for lithium ions and potassium ions for sodium ions) in a metal salt by bringing glass for chemical strengthening into contact with the metal salt by, for example, a method of immersing glass for chemical strengthening in a melt of a metal salt (e.g., potassium nitrate) containing metal ions having a large ion radius (typically, sodium ions or potassium ions).

A manufacturing method for chemically strengthened glass according to the present invention (hereinafter also abbreviated as a manufacturing method of the present invention) can increase the stress in a deep layer while lowering surplus stress that does not contribute to the strength because of inclusion of a first ion exchange process and a second ion exchange process described below. Since CS₅₀ and CS₉₀ are increased, the fracture resistance against drop impact is increased. Furthermore, the total value of compressive stress in a compressive stress layer can be decreased and stress values in a tensile stress layer that are occurred according to the total value of compressive stress are lowered, whereby an event that CT exceeds a CT limit can be avoided.

(First Ion Exchange Process)

A process of performing first ion exchange by immersing glass for chemical strengthening containing first alkali metal ions in a first molten salt composition containing second alkali metal ions having a larger ion radius than the first alkali metal ions.

(Second Ion Exchange Process)

A process, executed after the first ion exchange process, of performing second ion exchange by immersing the chemically strengthened glass obtained after the first ion exchange in a second molten salt composition containing first alkali metal ions and third alkali metal ions having a larger ion radius than the second alkali metal ions.

In the first ion exchange process, by immersing the glass for chemical strengthening containing first alkali metal ions in a first molten salt composition containing second alkali metal ions having a larger ion radius than the first alkali metal ions, a “first alkali metal ion-second alkali metal ion exchange” occurs in which first alkali metal ions in the glass for chemical strengthening is replaced with second alkali metal ions in the first molten salt composition. As a result, second alkali metal ions are introduced to a deep layer of the glass for chemical strengthening, whereby a deep compressive stress layer is formed.

In the second ion exchange process, by immersing the chemically strengthened glass obtained after the first ion exchange in a second molten salt composition containing first alkali metal ions and third alkali metal ions having a larger ion radius than the second alkali metal ions, a “second alkali metal ion-first alkali metal ion exchange” and a “second alkali metal ion-third alkali metal ion exchange” occur.

The “second alkali metal ion-first alkali metal ion exchange” in the second ion exchange process is replacement of second alkali metal ions in a surface layer of the chemically strengthened glass with first alkali metal ions in the second molten salt composition. In the “second alkali metal ion-first alkali metal ion exchange,” the second alkali metal ions in the glass surface layer that were introduced by the first ion exchange process move in two directions (i.e., the direction from the glass surface layer to the glass surface and the direction from the glass surface layer to a glass deep layer). Since second alkali metal ions move from the glass surface layer to the glass surface and are exchanged with first alkali metal ions there, the concentration of second alkali metal ions in the glass surface layer lowers, whereby the compressive stress caused by the second alkali metal ions is reduced. On the other hand, second alkali metal ions diffuse from the glass surface layer to a glass deep layer, whereby stress is produced in the glass deep layer.

The “second alkali metal ion-third alkali metal ion exchange” in the second ion exchange process is replacement of second alkali metal ions in the chemically strengthened glass obtained after the first ion exchange with third alkali metal ions in the second molten salt composition. In the “second alkali metal ion-third alkali metal ion exchange” in the second ion exchange process, the second alkali metal ions in the glass surface layer that were introduced by the first ion exchange process move in two directions (i.e., the direction from the glass surface layer to the glass surface and the direction from the glass surface layer to a glass deep layer). Since second alkali metal ions move from the glass surface layer to the glass surface and are exchanged with third alkali metal ions there, third alkali metal ions are introduced to a region having a depth of several tens of micrometers from the glass surface, whereby stress is produced in a glass surface layer. On the other hand, second alkali metal ions move from the glass surface layer to a glass deep layer and are diffused to the glass deep layer, whereby stress is produced in the glass deep layer.

With the above mechanisms, the manufacturing method for chemically strengthened glass including the first ion exchange process and the second ion exchange process can manufacture chemically strengthened glass that is superior in the fracture resistance against drop impact because CS₅₀ and CS₉₀ are large and in which stress valve in a tensile stress layer is lowered, whereby an event that CT exceeds a CT limit can be avoided, compared to the two-step chemically strengthened glass manufactured by the conventional manufactured method.

Including the following concentration control process, the manufacturing method of the present invention can manufacture chemically strengthened glass at high efficiency by continuing to use the first molten salt composition and the second molten salt composition.

(Second Molten Salt Composition Concentration Control Process)

A process of controlling the concentration of a second molten salt composition after being used for second ion exchange that is used as the second molten salt composition used for continuously conducted second ion exchange.

The manufacturing method of the present invention includes controlling the concentration of a second molten salt composition after being used for second ion exchange by adding first alkali metal ions to it. The expression “controlling the concentration of a second molten salt composition” as used herein means controlling the concentration of first alkali metal ions contained in the second molten salt composition.

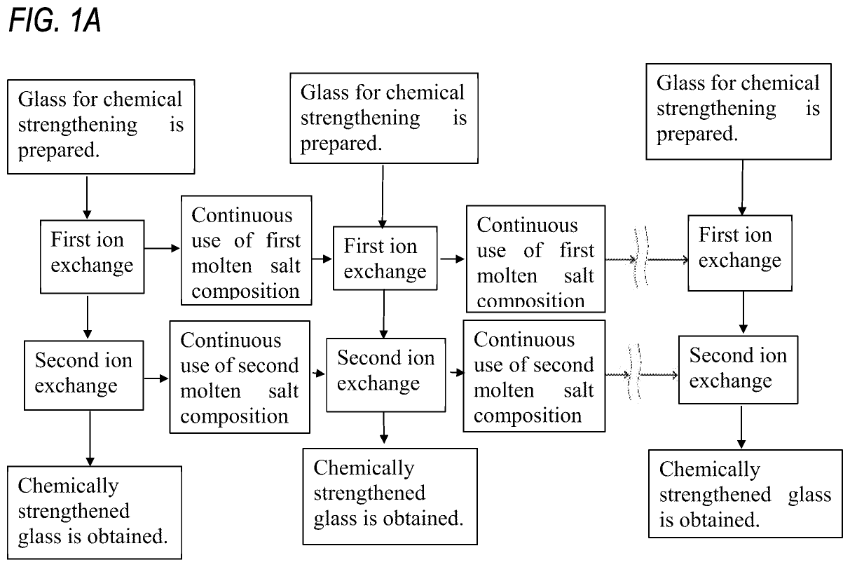

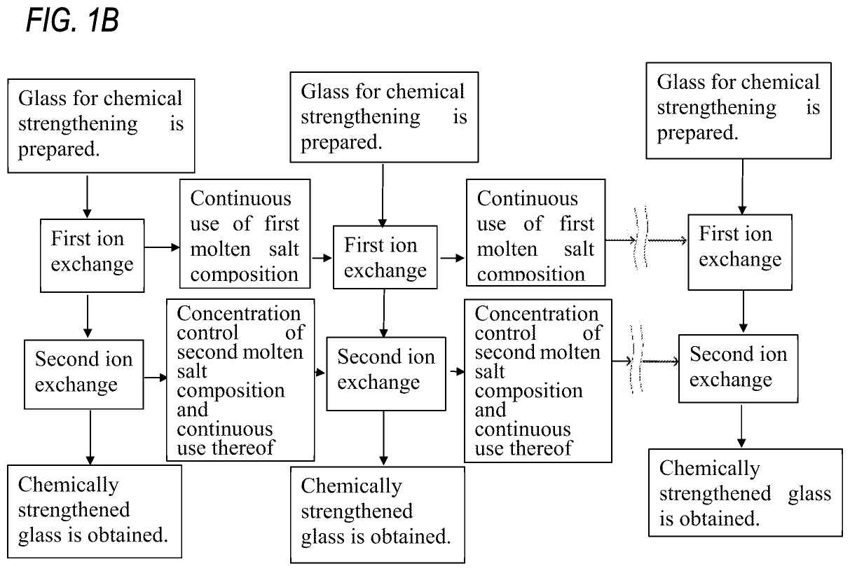

FIGS. 1A and 1B outline respective processes in which chemically strengthening treatment is performed by using molten salt compositions repeatedly in the manufacturing method for chemically strengthened glass including the first ion exchange process and the second ion exchange process. FIG. 1A illustrates an example conventional manufacturing method and FIG. 1B illustrates a manufacturing method according to an embodiment of the invention.

As illustrated in FIG. 1A, in the conventional manufacturing method, a first molten salt composition and a second molten salt composition are used continuously and CS₅₀ of the chemically strengthened glass decreases gradually as they are used continuously. The present inventors have found that CS₅₀ of the chemically strengthened glass decreases gradually as the first molten salt composition and the second molten salt composition are used continuously and the second molten salt composition degrades as the cumulative processed area of the chemically strengthened glass obtained after the first ion exchange processed using the second molten salt composition increases, and then the second molten salt composition is deteriorated.

FIG. 1B illustrates a process of the manufacturing method according to the embodiment of the present invention. As shown in FIG. 1B, in the manufacturing method of the present invention, a second molten salt composition after being used for second ion exchange is used in the next second ion exchange after its concentration is controlled by adding first alkali metal ions to it, whereby the decrease of CS₅₀ due to deterioration of the second molten salt composition is suppressed. This makes it possible to manufacture more pieces of highly strong chemically strengthened glass than in the conventional manufacturing method.

There are no particular limitations on how to add first alkali metal ions to a second molten salt composition after being used for second ion exchange as long as the advantages of the invention can be obtained. For example, the chemically strengthened glass obtained after the first ion exchange may be immersed in a second molten salt composition after being used for second ion exchange after first alkali metal ions are added to it. For another example, first alkali metal ions may be added to a second molten salt composition at the same time as the chemically strengthened glass obtained after the first ion exchange is immersed in the second molten salt composition.

In the case where the process for performing continuous use of the second molten salt composition is executed in a plurality of times, there are no particular limitations on the timing of adding first alkali metal ions to a second molten salt composition after being used for second ion exchange as long as the advantages of the invention can be obtained. The timing can be set as appropriate according to the composition of the glass for chemical strengthening, the composition of the first molten salt composition, the composition of the second molten salt composition, and other factors. For example, first alkali metal ions may be added either every time a second molten salt composition is used continuously or once per two or more times a second molten salt composition is used continuously.

In the control of the concentration of the second molten salt composition, the optimum amount and timing of addition of first alkali metal ions to the second molten salt composition vary depending on the composition of the glass for chemical strengthening, the conditions of the chemical strengthening, the composition of the first molten salt composition, the composition of the second molten salt composition, and other factors and can be set as appropriate. More specifically, for example, an amount and timing of addition of first alkali metal ions to the second molten salt composition can be set using the following items (1) to (3) as indices:

(1) the concentration of first alkali metal ions in the second molten salt composition per cumulative processed area of the chemically strengthened glass obtained after the first ion exchange processed using the second molten salt composition (m²/kg);

(2) the ratio of an evaluation value of CS₅₀ with respect to an initial value of CS₅₀ of the chemically strengthened glass manufactured; and

(3) a compressive stress value CS₀ at the surface of the chemically strengthened glass manufactured.

(1) Concentration of first alkali metal ions in the second molten salt composition per cumulative processed area (m²/kg) of the chemically strengthened glass obtained after the first ion exchange processed using the second molten salt composition

In the control of the concentration of the second molten salt composition, it is preferable to add first alkali metal ions to the second molten salt composition so that the concentration of first alkali metal ions in the second molten salt composition becomes 400 mass ppm/(m²/kg) or higher, more preferably 600 mass ppm/(m²/kg) or higher and further more preferably 800 mass ppm/(m²/kg) or higher, with the cumulative processed area (m²/kg) of the chemically strengthened glass obtained after the first ion exchange processed using the second molten salt composition being in a range of 0 to 1.5 m²/kg. By adding first alkali metal ions to the second molten salt composition, the concentration of first alkali metal ions in the second molten salt composition is kept within a prescribed range, whereby the influence of the second molten salt composition on the surface compressive stress CS₀ of the chemically strengthened glass manufactured is lowered. As a result, chemically strengthened glass whose surface compressive stress CS₀ is in a prescribed range can be manufactured continuously.

By using the second molten salt composition continuously while adding first alkali metal ions to the second molten salt composition so that the concentration of first alkali metal ions in the second molten salt composition per cumulative processed area (m²/kg) of the chemically strengthened glass obtained after the first ion exchange processed using the second molten salt composition falls within the above range, CS₅₀ of the chemically strengthened glass manufactured can be kept large and the proportion of high-strength products in the same processed amount can be increased. The same is true of a case of keeping CS₉₀ of the chemically strengthened glass manufactured large.

A concentration of first alkali metal ions in the second molten salt composition per cumulative processed area (m²/kg) of the chemically strengthened glass obtained after the first ion exchange processed using the second molten salt composition can be calculated by dividing a total amount of first alkali metal ions added to the second molten salt composition used in the second ion exchange by a cumulative processed area of chemically strengthened glass obtained after the first ion exchange that was brought into contact with the second molten salt composition.

(2) Ratio of an Evaluation value of CS₅₀ with Respect to an Initial Value of CS₅₀ of the Chemically Strengthened Glass Manufactured

In the concentration control of the second molten salt composition, it is preferable to add first alkali metal ions to the second molten salt composition so that the following evaluation value of CS₅₀ becomes 70% or larger, more preferably 75% or larger, further more preferably 80% or larger, and most preferably 85% or larger in the case where the initial value of CS₅₀ is regarded as 100%.

Initial value of CS₅₀: A compressive stress value (MPa) at a depth 50 μm from the surface in chemically strengthened glass obtained by first ion exchange and second ion exchange that uses a second molten salt composition that has not been used for second ion exchange.

Evaluation value of CS₅₀: A compressive stress value (MPa) at a depth 50 μm from the surface in chemically strengthened glass obtained by first ion exchange and second ion exchange that uses a continuous-use second molten salt composition that has been used for preceding second ion exchange.

By using the second molten salt composition continuously while controlling its concentration by adding first alkali metal ions to it so that the ratio of the evaluation value of CS₅₀ with respect to the initial value of CS₅₀ of the chemically strengthened glass manufactured falls within the above range, CS₅₀ of the chemically strengthened glass manufactured can be kept large and the proportion of high-strength products in the same processed amount can be increased. The same is true of a case of keeping CS₉₀ of the chemically strengthened glass manufactured large.

In the manufacturing method of the present invention, in the case where the amount and timing of addition of first alkali metal ions are determined using the ratio of an evaluation value of CS₅₀ with respect to its initial value as an index, the concentration of second alkali metal ions in the second molten salt composition, in a state that an evaluation value of CS₅₀ is equal to 70% with respect to an initial value of CS₅₀ of the chemically strengthened glass manufactured regarded as 100%, can be used as an index. The same is true of a case of keeping CS₉₀ of the chemically strengthened glass manufactured large.

More specifically, for example, to simulate a state that the concentration of second alkali metal ions in the second molten salt composition is made high by its continuous use, an inorganic salt source containing second alkali metal ions is added intentionally to the second molten salt composition by a prescribed amount. A formula that correlates the addition amount of the inorganic salt source containing second alkali metal ions with the initial value of CS₅₀ of glass obtained by chemically strengthening treatment is introduced and an addition amount of the inorganic salt source containing second alkali metal ions corresponding to a state that CS₅₀ has decreased from an initial value by 30% is calculated by linear approximation, for example. A concentration of second alkali metal ions that is calculated from the thus-obtained addition amount of the inorganic salt source containing second alkali metal ions can be used as a reference value for determination of an amount and timing of addition of an inorganic salt source containing first alkali metal ions to the second molten salt composition. For example, it is preferable to add a nitrate salt containing first alkali metal ions to the second molten salt composition by judging that the second molten salt composition has been deteriorated when the concentration of second alkali metal ions in the second molten salt composition has exceeded this reference value. The inorganic salt source containing first alkali metal ions is not limited to a nitrate salt mentioned above and may be a sulfate salt, a carbonate salt, or a phosphate salt.

### (3) Compressive Stress Value CS₀ at the Surface of the Chemically Strengthened Glass Manufactured

In the continuous use of the second molten salt composition, it is preferable to add first alkali metal ions to the second molten salt composition so that the compressive stress value CSₒ at the surface of the chemically strengthened glass manufactured becomes 700 MPa or larger, more preferably 750 MPa or larger, and further more preferably 800 MPa or larger.

By using the second molten salt composition continuously in the second ion exchange while controlling its concentration by adding first alkali metal ions to it so that CS₀ of the chemically strengthened glass manufactured falls within the above range, CS₅₀ of the chemically strengthened glass manufactured can be kept large and the proportion of high-strength products in the same processed amount can be increased. The same is true of a case of keeping CS₉₀ of chemically strengthened glass manufactured large.

### <Embodiment of Manufacturing Method for Chemically Strengthened Glass>

An embodiment of the manufacturing method of the present invention will be described below. In the present embodiment, first alkali metal ions are preferably lithium ions, second alkali metal ions are preferably sodium ions, and third alkali metal ions are preferably potassium ions.

### <<Glass for Chemical Strengthening>>

In the present embodiment, the glass for chemical strengthening is preferably lithium-containing glass and even more preferably lithium aluminosilicate glass.

More specifically, as for the composition of the glass for chemical strengthening, it is preferable that it contain, as represented by mol % based on oxides,

SiO₂ of 52% to 75%;

Al₂O₃ of 8% to 20%; and

Li₂O of 5% to 16%.

Preferable glass compositions will be hereinafter described.

SiO₂ is a component that constitutes a framework of glass. SiO₂ is also a component that increases chemical durability and lowering the probability of development of cracks when the glass surface is scratched.

The content of SiO₂ is preferably 52% or higher, more preferably 55% or higher, further more preferably 60% or higher, and particularly preferably 65% or higher. On the other hand, from the viewpoint of increasing the meltability, the content of SiO₂ is preferably 75% or lower, more preferably 72% or lower, further more preferably 70% or lower, and particularly preferably 68% or lower.

Al₂O₃ is a component that is effective from the viewpoints of improving the ion exchange performance at the time of chemical strengthening and increasing the surface compressive stress after the strengthening.

The content of Al₂O₃ is preferably 8% or higher, more preferably 9% or higher, further more preferably 10% or higher, and particularly preferably 11% or higher. Typically, the Al₂O₃ content is 12% or higher. On the other hand, if the content of Al₂O₃ is too high, crystals grow easily while the materials are in a molten state and the production yield is prone to lower due to devitrification defects. Furthermore, the glass viscosity increases to lower the meltability. The content of Al₂O₃ is preferably 20% or lower, more preferably 19% or lower, and further more preferably 18% or lower.

SiO₂ and Al₂O₃ are both a component that stabilizes the glass structure. To lower the brittleness, the total content of SiO₂ and Al₂O₃ is preferably 65% or higher, more preferably 70% or higher, and further more preferably 75% or higher.

Li₂O is a component for producing surface compressive stress by ion exchange as well as a component for increasing the glass meltability. Because the glass for chemical strengthening contains Li₂O, by a method of performing ion exchange that exchanges lithium ions to sodium ions, further exchanges sodium ions to potassium ions, a stress profile can be obtained in which the surface compressive stress is large and the compressive stress layer is thick. From the viewpoint of facilitating formation of a preferable stress profile, the content of Li₂O is preferably 5% or higher, more preferably 7% or higher, further more preferably 9% or lower, particularly preferably 10% or higher, and most preferably 11% or higher.

On the other hand, if the content of Li₂O is too high, the crystal growth rate at the time of glass shaping becomes so high as to worsen the problem of production yield reduction due to devitrification defects. The content of Li₂O is preferably 20% or lower, more preferably 16% or lower, further more preferably 14% or lower, and particularly preferably 12% or lower.

Whereas Na₂O and K₂O are not essential components, they are components for increasing the glass meltability as well as components for lowering the glass crystal growth rate. To enhance the ion exchange performance, it is preferable that they be contained at 2% or higher in total. The total content of Na₂O and K₂O is preferably 10% or lower, more preferably 9% or lower, further more preferably 8% or lower, particularly preferably 7% or lower, and most preferably 5% or lower.

Na₂O is a component for forming a surface compressive layer in chemically strengthening treatment that uses a potassium salt as well as a component for increasing the glass meltability. To have it exhibit these effects, the content of Na₂O is preferably 1% or higher, more preferably 2% or higher, further more preferably 3% or higher, and particularly preferably 4% or higher. On the other hand, from the viewpoints of preventing reduction of the surface compressive stress (CS₀) in strengthening treatment using a sodium salt, increasing CS₅₀ and realizing a close-to-linear profile having no bending point, the content of Na₂O is preferably 8% or lower, more preferably 7% or lower, further more preferably 6% or lower, and particularly preferably 5% or lower.

K₂O may be contained to, for example, enhance the ion exchange performance. In the case where K₂O is contained, the content K₂O is preferably 0.1% or higher, more preferably 0.15% or higher, and particularly preferably 0.2% or higher. To prevent devitrification more surely, the content of K₂O is 0.5% or higher, more preferably 1.2% or higher. On the other hand, a high content of K is a factor in brittleness reduction and reduction of surface layer stress due to reverse exchange at the time of strengthening. Thus, the content of K₂O is preferably 5% or lower and more preferably 3% or lower.

MgO may be contained to, for example, lower the viscosity during melting. The content of MgO is preferably 1% or higher, more preferably 2% or higher, and further more preferably 3% or higher. On the other hand, if the MgO content is too high, it becomes difficult to form a thick compressive stress layer at the time of chemically strengthening treatment. The content of MgO is preferably 15% or lower, more preferably 10% or lower, further more preferably 8% or lower, and particularly preferably 6% or lower.

ZrO₂ may not be contained. However, from the viewpoint of increasing the surface compressive stress of the chemically strengthened glass, it is preferable that ZrO₂ be contained. The content of ZrO₂ is preferably 0.1% or higher, more preferably 0.15% or higher, further more preferably 0.2% or higher, and particularly preferably 0.25% or higher. Typically, the ZrO₂ content is 0.3% or higher. On the other hand, if the content of ZrO₂ is too high, devitrification defects are prone to occur and it becomes difficult to increase the compressive stress value at the time of chemically strengthening treatment. The ZrO₂ content is preferably 2% or lower, more preferably 1.5% or lower, further more preferably 1% or lower, and particularly preferably 0.8% or lower.

The content of Y₂O₃ is preferably 0.1% or higher, more preferably 0.2% or higher, further more preferably 0.5% or higher, and particularly preferably 1% or higher. On the other hand, if the content of Y₂O₃ is too high, it becomes difficult to form a thick compressive stress layer at the time of chemically strengthening treatment. The content of Y₂O₃ is preferably 5% or lower, more preferably 3% or lower, further more preferably 2% or lower, and particularly preferably 1.5% or lower.

It is preferable that the glass for chemical strengthening have the composition as described above. Glass materials are mixed as appropriate so as to obtain glass having the above-described composition and are heat-melted in a glass melting furnace. Resulting molten glass is homogenized by bubbling, stirring, addition of a refining agent, etc., shaped into a glass sheet having a prescribed thickness, and annealed. Alternatively, the resulting molten glass may be shaped into glass sheets by forming it into a block shape, annealing the glass block, and cutting it.

Example methods of shaping into a sheet shape include a float method, a press method, a fusion method, and a down draw method. In particular, to manufacture a large glass sheet, employment of the float method is preferable. Continuous shaping methods other than the float method, such as the fusion method and the down draw method, are also preferable.

The glass for chemical strengthening may be crystallized glass. Preferable crystallized glass is crystallized glass containing at least one kind of crystal selected from the group consisting of a lithium silicate crystal, a lithium aluminosilicate crystal, and a lithium phosphate crystal. The lithium silicate crystal is preferably a lithium metasilicate crystal, a lithium disilicate crystal, or the like. The lithium phosphate crystal is preferably a lithium orthophosphate crystal or the like. The lithium aluminosilicate crystal is preferably a β-spodumene crystal, a petalite crystal, or the like.

In the present specification, the term “amorphous glass” means glass in which no diffraction peak indicating crystals is found by a powder X-ray diffraction method. The term “crystallized glass” means glass that is obtained by precipitating crystals by subjecting amorphous glass to heat treatment and contains crystals.

One preferable example composition of amorphous glass is a composition including, as represented by mol % based on oxides, SiO₂ of 45% to 70%, Al₂O₃ of 0.5% to 10%, Li₂O of 20% to 40%, P₂O₅ of 0% to 6%, ZrO₂ of 0% to 8%, Na₂O of 0% to 10%, K₂O of 0% to 5%, and Y₂O₃ of 0% to 2%.

Another preferable example composition of amorphous glass is a composition including, as represented by mol % based on oxides, SiO₂ of 40% to 70%, Li₂O of 10% to 35%, Al₂O₃ of 1% to 15%, P₂O₅ of 0.5% to 5%, ZrO₂ of 0.5% to 5%, B₂O₃ of 0% to 10%, Na₂O of 0% to 3%, K₂O of 0% to 1%, and SnO₂ of 0% to 4%.

Another preferable example composition of amorphous glass is a composition including, as represented by mol % based on oxides, SiO₂ at 50% of 70%, Li₂O of 15% to 30%, Al₂O₃ of 1% to 10%, P₂O₅ of 0.5% to 5%, ZrO₂ of 0.5% to 8%, MgO of 0.1% to 10%, Y₂O₃ at 0% of 5%, B₂O₃ of 0% to 10%, Na₂O of 0% to 3%, K₂O of 0% to 1%, and SnO₂ of 0% to 2%.

Another preferable example composition of amorphous glass is a composition including, as represented by mol % based on oxides, SiO₂ of 60% to 72%, Li₂O of 20% to 32%, Al₂O₃ of 0% to 6%, P₂O₅ of 0.7% to 2.2%, ZrO₂ of 1.7% to 4.5%, B₂O₃ of 0% to 2%, Na₂O of 0% to 2%, and K₂O of 0% to 2%.

Another preferable example composition of amorphous glass is a composition including, as represented by mol % based on oxides, SiO₂ of 60% to 72%, Li₂O of 20% to 32%, Al₂O₃ of 0% to 6%, P₂O₅ of 0.7% to 2.2%, ZrO₂ of 1.7% to 4.5%, B₂O₃ of 0% to 2%, Na₂O of 0% to 2%, and K₂O of 0% to 2%, and, as other components, the composition preferably includes, as represented by mol % based on oxides, SnO₂ of 0.05% to 0.5%, Fe₂O₃ of 0% to 0.5%, MgO of 0% to 1%, ZnO of 0% to 1%, BaO of 0% to 1%, SrO of 0% to 1%, La₂O₃ of 0% to 1%, GeO₂ of 0% to 1%, and Ta₂O₅ of 0% to 1%.

To increase the mechanical strength,t the crystallization ratio of the crystallized glass is preferably0% or larger, more preferably 15% or larger, further more preferably 20% or larger, and particularly preferably 25% or larger. To increase the transparency, the crystallization ratio of the crystallized glass is preferably 70% or smaller, more preferably 60% or smaller, and particularly preferably 50% or smaller. Crystallized glass being small in crystallization ratio is superior in being shaped easily by bend shaping with heating. A crystallization ratio can be calculated by the Rietveld method from X-ray diffraction intensity. The Rietveld method is described in “Crystal Analysis Handbook,” edited by the Crystal

Analysis Handbook edition committee of The Crystallographic Society of Japan, Kyoritsu Shuppan Co., Ltd., 1999, pp. 492-499.

To increase the transparency, the average particle diameter of precipitated crystals of crystallized glass is preferably 300 nm or smaller, more preferably 200 nm or smaller, further more preferably 150 nm or smaller, and particularly preferably 100 nm or smaller. An average particle diameter of precipitated crystals can be determined from a transmission electron microscope (TEM) image and can be estimated from a scanning electron microscope (SEM) image.

In the following, the first ion exchange process and the second ion exchange process will be described in detail in which the first alkali metal ions are lithium ions, the second alkali metal ions are sodium ions, and the third alkali metal ions are potassium ions.

### <<First Ion Exchange Process>>

In the present embodiment, the first ion exchange process is a process of performing ion exchange by immersing the glass for chemical strengthening containing lithium ions in a first molten salt composition containing sodium ions which are larger in ion radius than lithium ions.

In the first ion exchange process, sodium ions are introduced into a surface layer of the glass for chemical strengthening by “Li—Na exchange” in which lithium ions contained in the glass for chemical strengthening are replaced by sodium ions contained in the first molten salt composition.

In the present specification, the term “molten salt composition” means a composition containing molten salt. Examples of a molten salt contained in a molten salt composition include a nitrate salt, a sulfate salt, a carbonate salt, and a chloride salt.

Examples of nitrate salt include lithium nitrate, sodium nitrate, potassium nitrate, cerium nitrate, rubidium nitrate, and silver nitrate. Examples of sulfate salt include lithium sulfate, sodium sulfate, potassium sulfate, cesium sulfate, rubidium sulfate, and silver sulfate. Examples of chloride salt include lithium chloride, sodium chloride, potassium chloride, cesium chloride, rubidium chloride, and silver chloride. These molten salts may be used either singly or in a combination of plural kinds.

The molten salt composition is preferably a composition having a nitrate salt as a base component, more preferably a composition having sodium nitrate or potassium nitrate as a base component. The expression “as a base component” means that the content of the salt in the molten salt composition is 80 mass % or higher. The total content of sodium nitrate and potassium nitrate is preferably 90 mass % or higher, more preferably 100 mass %.

In the present embodiment, a molten salt composition containing sodium nitrate is used as the first molten salt composition. The first molten salt composition may also contain potassium nitrate.

In the case where potassium nitrate is added in the first molten salt composition, the concentration of potassium nitrate is preferably higher than 10 mass %, more preferably 20 mass % or higher, and further more preferably 30 mass % or higher. By setting the concentration of potassium nitrate in this range, sufficient stress can be produced in a surface layer in the next, second ion exchange process. In the case where the concentration of potassium nitrate added in the first molten salt composition is higher than 10 mass %, a phenomenon that sodium ions in a glass surface layer decreases excessively by “Na—Li exchange” in the subsequent second ion exchange process to lower CS₅₀ and CS₉₀ can be suppressed meaningfully.

On the other hand, the concentration of potassium nitrate in the first molten salt composition is preferably 80 mass % or lower and more preferably 70 mass % or lower. In the case where the concentration of potassium nitrate in the first molten salt composition is 80 mass % or lower, a sufficient amount of sodium ions can be introduced into inside the glass.

To keep CS₅₀ large, the concentration of sodium nitrate in the first molten salt composition is preferably lower than that of potassium nitrate in the first molten salt composition. To keep CS₅₀ large, the concentration of potassium nitrate in the first molten salt composition is preferably higher than 50 mass %. To keep CS₅₀ large, the concentration of sodium nitrate in the first molten salt composition is preferably 50 mass % or lower, more preferably 45 mass % or lower and further more preferably 40 mass % or lower. The concentration of sodium nitrate in the first molten salt composition is preferably 20 mass % or higher and more preferably 30 mass % or higher. To keep CS₉₀ large, it is preferable that the concentration of sodium nitrate in the first molten salt composition is higher than that of potassium nitrate therein. For example, the concentration of potassium nitrate is preferably lower than 50 mass %, more preferably 40 mass % or lower, and further more preferably 30 mass % or lower. In the case where the concentration of sodium nitrate in the first molten salt composition is in this range, a sufficient amount of sodium ions can be introduced into inside the glass.

It is preferable that a maximum tensile stress value CT₁ of a stress profile that is formed inside the glass by the first ion exchange process be larger than a CT limit. Where the maximum tensile stress value CT₁ obtained after the first ion exchange is larger than the CT limit, a sufficiently large compressive stress is produced by the first ion exchange and CS₅₀ can be kept large even after stress values in a glass surface layer are lowered by the subsequent second ion exchange.

In the present embodiment, ion exchange is performed so that the maximum tensile stress value CT₁ of the chemically strengthened glass obtained after the first ion exchange becomes larger than 17.5/(t/2−DOL/1,000), in which t is the thickness (mm) of the chemically strengthened glass and DOL is the compressive stress layer depth (μm). Where the maximum tensile stress value CT₁ is larger than 17.5/(t/2−DOL/1,000), compressive stress can be introduced so that the CT₁ exceeds CT limit.

In the present embodiment, the temperature of the first molten salt composition used in the first ion exchange process is preferably 360° C. or higher, more preferably 421° C. or higher, and further more preferably 430° C. or higher. In the case where the temperature of the first molten salt composition is 360° C. or higher, the ion exchange proceeds easily and compressive stress can be introduced in such a range that CT₁ exceeds the CT limit. From the viewpoints of occurrence of danger and variation of the first molten salt composition caused by evaporation, temperature of the first molten salt composition is usually set at 450° C. or lower.

From the viewpoint of increasing the surface compressive stress, in the first ion exchange process, the time for which the glass for chemical strengthening is immersed in the first molten salt composition is preferably 0.5 hour or longer, more preferably 1 hour or longer. If the immersion time is too long, not only the productivity lowers but also the compressive stress may lower due to a relaxation phenomenon. Thus, the immersion time is usually set at 12 hours or shorter.

### <<Second Ion Exchange Process>>

In the present embodiment, the second ion exchange process is a process of performing ion exchange by immersing the chemically strengthened glass obtained after the first ion exchange process in a second molten salt composition that has potassium nitrate as a base component and contains a small amount of lithium ions.

In the second ion exchange process, “Na—K exchange” in which sodium ions in the glass are replaced by potassium ions occurs, whereby potassium ions are introduced into a glass surface layer having a thickness of several tens of micrometers. At the same time, the concentration of sodium ions in a glass surface layer is lowered by “Na—Li exchange” (inverse ion exchange), whereby the compressive stress produced by sodium ions is reduced.

In the present embodiment, in the second ion exchange, it is preferable that the compressive stress in chemically strengthened glass be reduced while CS₅₀ and CS₉₀ are maintained and be adjusted so that CT becomes smaller than or equal to the CT limit. Influence of the stress in the glass surface layer in which potassium ions have been introduced is not reflected in a stress profile that is measured by a scattered light photoelastic stress meter (SLP). Thus, tensile stress reduction caused by the reduction of sodium ions can be detected using a stress profile that is measured by the scattered light photoelastic stress meter (SLP).

In the present embodiment, it is preferable that the second molten salt composition contain lithium nitrate and potassium nitrate. The concentration of potassium nitrate in the second molten salt composition is preferably 85 mass % or higher, more preferably 90 mass % or higher, and further more preferably 95 mass % or higher. Although there are no particular limitations on the upper limit, the concentration of potassium nitrate is usually 99.9 mass % or lower.

The mass ratio of (sodium ions)/(lithium ions) in the second molten salt composition is preferably 0 or larger and 15 or smaller, more preferably 0.2 or larger and 10 or smaller, and further more preferably 0.4 or larger and 5 or smaller. The mass ratio of (sodium ions)/(lithium ions) being in the above range means lithium ions are added to the second molten salt composition intentionally.

For example, in the case where sodium nitrate is added to the second molten salt composition, lithium ions in the glass are replaced by sodium ions in the second molten salt composition (Li—Na exchange), whereby lithium ions are mixed into the second molten salt composition. The amount of lithium ions that are mixed into the second molten salt composition increases according to the amount of sodium ions contained in the second molten salt composition.

On the other hand, the replacement of sodium ions in the glass with lithium ions mixed in the second molten salt composition (Na—Li exchange) is suppressed by the sodium ions in the second molten salt composition. Thus, the compressive stress that is produced in the glass surface layer in the first ion exchange process can be weakened by effectively causing the replacement of sodium ions in the glass with lithium ions mixed in the second molten salt composition (Na—Li exchange) by adding lithium ions in the second molten salt composition intentionally by an amount that is larger than or equal to an amount of sodium ions mixed in it by addition of sodium nitrate.

In the present embodiment, the concentration of lithium ions in the second molten salt composition is preferably 100 mass ppm or higher and 10,000 mass ppm or lower, more preferably 200 mass ppm or higher and 5,000 mass ppm or lower, and further more preferably 300 mass ppm or higher and 2,500 mass ppm or lower.

Where the concentration of lithium ions in the second molten salt composition is in the above range, sodium ions that were introduced in the vicinity of the glass surface in the first ion exchange process are replaced with lithium ions in the second molten salt composition in parallel with replacement of those sodium ions with potassium ions in the second molten salt composition, whereby the stress at the glass surface can be weakened.

In the present embodiment, it is preferable to add lithium nitrate to the second molten salt composition by 0.01 to 0.2 mass % every time processed area 0.1 m²/kg is achieved, more preferably 0.015 to 0.15 mass % and further more preferably 0.02 to 0.1 mass %. By setting the amount of addition of lithium nitrate to the second molten salt composition in the above range, the replacement of sodium ions in the glass with lithium ions in the second molten salt composition (Na—Li exchange) is caused effectively, whereby the compressive stress that is produced in the glass surface layer in the first ion exchange process can be weakened.

In the present embodiment, the second molten salt composition may contain sodium nitrate. In the case where the second molten salt composition may contain sodium nitrate, the concentration of sodium nitrate is preferably higher than 0 mass %, more preferably higher than 0.1 mass %, and further preferably 0.5 mass % or higher. Where the concentration of sodium nitrate in the second molten salt composition is in the above range, the effect of increasing CS₅₀ is enhanced. The presence of sodium nitrate in the second molten salt composition causes Li—Na exchange to proceed also in the second ion exchange process, whereby CS₅₀ is increased. Furthermore, where the concentration of sodium nitrate in the second molten salt composition is in the above range, the period when the effect of the invention continues to be exhibited can be elongated without replacing the second molten salt composition, whereby the amount of glass processed can be increased.

The concentration of sodium nitrate in the second molten salt composition is preferably 5 mass % or lower, more preferably 3 mass % or lower, further more preferably 2 mass % or lower, and most preferably 1 mass % or lower. Setting the concentration of sodium nitrate in the second molten salt composition lower than or equal to 5 mass % makes it easier to suppress the maximum tensile stress value CT₂ value of the chemically strengthened glass obtained after the second ion exchange within the CT limit.

The second molten salt composition may further contain an additive(s) other than nitrate salts. Examples of additive include a silicic acid and a particular inorganic salt. Where the second molten salt composition contains an additive(s), CS₀ of a combined profile of the film stress measurement (FSM) and a scattered light photoelastic stress meter (SLP) can be increased. A detailed description will be made below.

In the present embodiment, the second molten salt composition may contain a silicic acid as an additive. The silicic acid is a compound that consists of silicon atoms, hydrogen atoms, and oxygen atoms and is expressed by a chemical formula nSiO₂.xH₂O, in which n and x are natural numbers. Examples of silicic acid include metasilicic acid (SiO₂.H₂O), disilicic acid (2SiO₂.H₂O), orthosilicic acid (SiO₂.2H₂O), pyrosilicic acid (2SiO₂.3H₂O), and silica gel (SiO₂.mH₂O, m is a real number of 0.1 to 1).

Where a silicic acid is contained, since the silicic acid absorbs a lithium ion to facilitate potassium ions to enter the glass, the stress in a surface layer having a thickness of several micrometers in an FSM and SLP combined profile can be increased while the CT is suppressed. Since lithium ions react with sodium ions through “Na—Li exchange,” the progress of “Na—K exchange” can be suppressed. Thus, the addition of a silicic acid is effective in accelerating “Na—K exchange.”

In the present embodiment, in the case where a silicic acid is added to the second molten salt composition, the concentration of the silicic acid is preferably 0.1 mass % or higher, more preferably 0.3 mass % or higher, and most preferably 0.5 mass % or higher. On the other hand, the concentration of the silicic acid is preferably 3 mass % or lower, more preferably 2 mass % or lower, and most preferably 1 mass % or lower.

Where the concentration of the silicic acid in the second molten salt composition is in the above range, the surface layer stress in a SLP stress profile can be reduced meaningfully by “Na—Li exchange.” That is, the effects of a rise of compressive stress in a surface layer having a thickness of several micrometers in a combined profile because of introduction of potassium ions and reduction of stress in a layer to DOL in an SLP profile through decrease of sodium ions can be obtained.

It is preferable that the silicic acid be silica gel (SiO₂.mH₂O, m is a real number of 0.1 to 1). Since silica gel has a relatively large size of secondary particles, silica gel is sedimented easily and hence has an advantage that it can be input and collected easily. Since particles of silica gel do not swirl as particles, silica gel can secure safety of workers. Furthermore, since silica gel is a porous body, a molten salt tends to be supplied to the surfaces of primary particles, silica gel is superior in reactivity and exhibits a great effect of absorbing lithium ions.

The second molten salt composition may contain a particular inorganic substance (hereinafter referred to as flux) as an additive. The flux is preferably a carbonate salt, a hydrogen carbonate salt, a phosphate salt, a sulfate salt, a hydroxide, and a chloride. It is more preferable that flux be at least one selected from the group consisting of K₂CO₃, Na₂CO₃, KHCO₃, NaHCO₃, K₃PO₄, Na₃PO₄, K₂SO₄, Na₂SO₄, KOH, NaOH, KCl, and NaCl. It is further more preferable that the flux be at least one selected from the group consisting of K₂CO₃ and Na₂CO₃. It is particularly preferable that the flux be K₂CO₃.

In the present embodiment, whereas lithium ions in the second molten salt composition can weaken compressive stress originating from sodium ions in the glass through “Na—Li exchange”, they may obstruct “Na—K exchange.” If “Na—K exchange” is impaired, it becomes difficult to obtain the effect of increasing CS₀ in a combined profile by introducing potassium ions in a glass surface layer having a depth of several micrometers. In the second molten salt composition, the mutual energy with an anion generated from flux increases in order of a potassium ion, a sodium ion, and a lithium ion. Where the second molten salt composition contains flux, since anions attract lithium ions, the phenomenon that lithium ions impair “Na—K exchange” can be suppressed, allowing potassium ions to be introduced into the glass easily. On the other hand, since anions do not suppress “Na—Li exchange,” the stress originating from sodium ions in the glass can be weakened. As a result, the effect of increasing CS₀ in a combined profile can be obtained while the effect of weakening the stress in a layer from the glass surface to DOL in an SLP profile is maintained.

The content of flux added in the second molten salt composition is preferably 0.1 mass % or higher, in which case the effect of increasing CS₀ can be obtained easily. On the other hand, to suppress variation of the properties of the glass surface, the content of flux is preferably 2 mass % or lower, more preferably 1 mass % or lower.

In the present embodiment, it is preferable that the second molten salt composition contain one of a silicic acid and a carbonate salt. It is more preferable that the second molten salt composition contain both of a silicic acid and a carbonate salt because in that case the effect of increasing CS₀ can be obtained particularly easily.

In the present embodiment, it is preferable that in the second ion exchange process the chemically strengthened glass obtained after the first ion exchange be immersed in the second molten salt composition whose temperature is at 360° C. or higher. When the temperature of the second molten salt composition is 360° C. or higher, ion exchange proceeds easily. From the viewpoint of occurrence of danger and variation of the second molten salt composition caused by evaporation, the temperature of the second molten salt composition is usually set a 450° C. or lower. From the viewpoint of preventing excessive stress decrease due to “Na—Li exchange”, it is preferable that the temperature of the second molten salt composition be set at 400° C. or lower.

In the present embodiment, the time in which the chemically strengthened glass obtained after the first ion exchange is immersed in the second molten salt composition in the second ion exchange process is preferably 0.1 hour or longer, in which case sodium ions introduced into a layer close to the glass surface in the first ion exchange process are replaced sufficiently by lithium ions in the second molten salt composition and hence the stress at the glass surface can be weakened easily. The immersion time is even preferably 0.3 hour or longer. From the viewpoint of preventing excessive stress decrease by “Na—Li exchange,” the immersion time is preferably 3 hours or shorter.

In the present embodiment, it is preferable that the time t2 (min) in which the chemically strengthened glass obtained after the first ion exchange is immersed in the second molten salt composition whose temperature is at T (° C.) satisfy the following formula, in which case the stress at the glass surface can be weakened to a proper value:

−0.35T+173<t2<'11.4T+720.

The time t2 (min) is preferably longer than (−0.38T+173), more preferably (−0.36T+167) or longer, and further more preferably (−0.35T+167 or longer. On the other hand, the time t2 (min) is preferably shorter than (−1.4T+720), more preferably (1.3T+670) or shorter, and further more preferably (−1.2T+620) or shorter.

In the second ion exchange process, it is preferable to adjust the temperature of the second molten salt composition in which the chemically strengthened glass obtained after the first ion exchange is to be immersed and the immersion time. In the present embodiment, in the case where the temperature of the second molten salt composition in which the chemically strengthened glass obtained after the first ion exchange is to be immersed is, for example, 380° C., the immersion time is preferably 10 minutes or longer and 180 minutes or shorter. In the case where the temperature of the second molten salt composition in which the chemically strengthened glass obtained after the first ion exchange is to be immersed is 400° C., the immersion time is preferably 5 minutes or longer and 150 minutes or shorter. In the case where the temperature of the second molten salt composition in which the glass for chemical strengthening is to be immersed is higher than 400° C., the immersion time is preferably 110minutes or shorter.

As described above, it is preferable that the second ion exchange be performed so that the maximum tensile stress value CT₂ of the chemically strengthened glass obtained after the second ion exchange becomes smaller than or equal to the CT limit.

In the present embodiment, it is preferable that the chemical strengthening be performed so that the maximum tensile stress value CT₂ (MPa) of the chemically strengthened glass obtained after the second ion exchange becomes 50% to 93% of the maximum tensile stress value CT₁ (MPa) of the chemically strengthened glass obtained after the first ion exchange, more preferably 60% or larger and further more preferably 75% or larger. On the other hand, it is preferable that the chemical strengthening be performed so that the maximum tensile stress value CT₂ (MPa) of the chemically strengthened glass obtained after the second ion exchange becomes 90% or smaller of the maximum tensile stress value CT₁ (MPa).

In the present embodiment, it is preferable that the chemical strengthening be performed so that the maximum tensile stress value CT₂ (MPa) after the second ion exchange is smaller than or equal to 19.5/(t/2−/1,000), in which t is the sheet thickness of the chemically strengthened glass and DOL is the depth (μm) of a compressive stress layer.

### <Chemically Strengthened Glass>

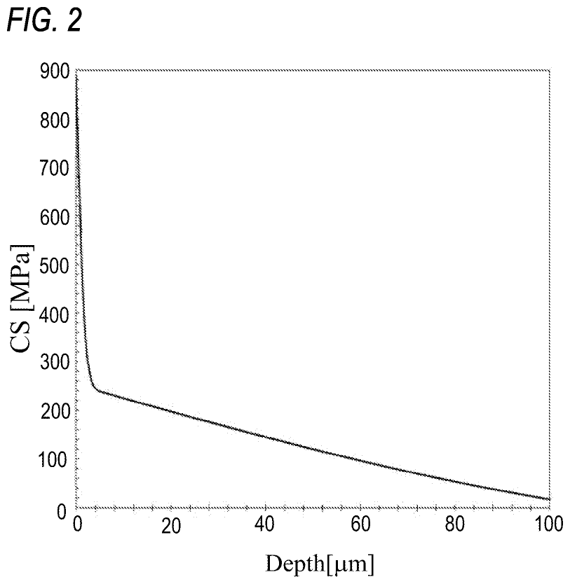

FIG. 2 shows an example stress profile of chemically strengthened glass manufactured by the manufacturing method of the present invention. As shown in FIG. 2, in a stress profile of the chemically strengthened glass manufactured by the manufacturing method of the present invention, the compressive stress CS₀ at the glass surface is smaller than in chemically strengthened glass manufactured by the conventional two-step chemical strengthening that produces approximately the same compressive stress layer depth. Although the integration area of the compressive stress is therefore smaller than in a stress profile having approximately the same compressive stress layer depth, the compressive stress in a thickness range between a depth 50 μm from the glass surface and a compressive stress layer depth (hereinafter also referred to as “DOLzero”) of the chemically strengthened glass is the same as or larger than in the stress profile having approximately the same compressive stress layer depth.

Furthermore, in a stress profile of the chemically strengthened glass manufactured by the manufacturing method of the present invention, although the integration area of the compressive stress is approximately the same as in a stress profile of chemically strengthened glass manufactured by the conventional two-step chemical strengthening, CS₀ is smaller and the compressive stress in the thickness range between the depth 50 um from the glass surface and DOLzero (μm) is larger than in the stress profile of chemically strengthened glass manufactured by the conventional two-step chemical strengthening. As a result, the chemically strengthened glass manufactured by the manufacturing method of the present invention, the CT values does not exceed the CT limit, whereby it exhibits a high drop strength and its breaking in an impact mode can be suppressed.

To increase strength, the thickness t (mm) of the chemically strengthened glass according to the present invention is preferably 0.8 mm or smaller, more preferably 0.7 mm or smaller, further more preferably 0.65 mm or smaller, and particularly preferably 0.6 mm or smaller. The strength increases as the thickness t becomes smaller. The thickness t is typically 0.02 mm or larger.

### EXAMPLES

Glass materials were mixed so as to have the following composition as represented by mol % based on oxides and subjected to weighing so that glass of 400 g will be manufactured. The mixed materials were put into a platinum crucible and melted in an electric furnace at 1,500° C. to 1,700° C. for about 3 hours, defoamed and homogenized. The glass composition was as follows: SiO₂: 68.9%, Al₂O₃: 12.4%, Y₂O₃, 1.3%; ZrO₂, 0.3%; Li₂O, 10.8%; Na₂O, 4.8%; K₂O, 1.2%; and the other components, 0.3%.

The molten glass thus obtained was put into a metal die, held at a temperature that is about 50° C. higher than a glass transition temperature for 1 hour, and then cooled to room temperature at a rate of 0.5° C./min, whereby a glass block was obtained. After the glass block was cut and ground, both surfaces of each of resulting glass sheets were finally mirror-polished, whereby glass sheets having a thickness 0.65 mm were obtained.

Using those glass sheets as the glass for chemical strengthening, they were subjected to chemically strengthening treatment under the following conditions and then to processes of Examples 1 and 2. Example 1 was an Inventive Example and Example 2 was a Comparative Example.

### Example 1

### (1) First Ion Exchange Process

The glass for chemical strengthening was subjected to first ion exchange by immersing the glass for chemical strengthening in a first molten salt composition (containing KNO₃ of 60 mass % and NaNO₃ of 40 mass %) at 420° C. for 75 minutes.

### (2) Second Ion Exchange Process

The chemically strengthened glass obtained after the first ion exchange process was subjected to second ion exchange by immersing it in a second molten salt composition (containing KNO₃ of 99.4 mass % and LiNO₃ of 0.6 mass %) at 420° C. for 30 minutes, and then the chemically strengthened glass was manufactured.

### (3) Process of Causing Continuous Use of First Molten Salt Composition

A first molten salt composition used in a first ion exchange process was used continuously in the next first ion exchange process to which a new glass for chemical strengthening was subjected, whereby the first molten salt composition was used repeatedly.

### (4) Process of Causing Continuous Use of Second Molten Salt Composition

A second molten salt composition used in a second ion exchange process was used continuously in the next second ion exchange process to which is a new chemically strengthened glass obtained after the first ion exchange was subjected, whereby the second molten salt composition was used repeatedly.

### (5) Process of Controlling Concentration of Second Molten Salt Composition

The concentration of a second molten salt composition was controlled by adding lithium nitrate to a second molten salt composition so that the amount of addition of lithium ions to the second molten salt composition becomes 150 mass ppm/(0.1 m²/kg) per cumulative processed area of the chemically strengthened glass obtained after the first ion exchange processed using the second molten salt composition. A resulting second molten salt composition was used in (4) the process of causing continuous use of second molten salt composition.

### Example 2

Chemically strengthened glass was manufactured in the same manner as in Example 1 except that (5) which is the process of controlling concentration of second molten salt composition was not executed.

Pieces of the chemically strengthened glass thus manufactured were evaluated by the following methods.

### [Stress Measurement Using Scattered Light Photoelastic Stress Meter]

Stress of chemically strengthened glass was measured by the method described in WO 2018/056121 using a scattered light photoelastic stress meter (SLP-1000 produced by Orihara Industrial Co., Ltd.). Stress values were calculated using software SlpIV (ver. 2019.01.10.001) attached to the scattered light photoelastic stress meter (SLP-1000 produced by Orihara Industrial Co., Ltd.).

A function σ(x)=a₁×erfc(a₂×x)+a₃×erfc(a₄×x)+a₅ was used for calculating a stress profile, where aᵢ (i=1 to 5) is fitting parameter and erfc is a complementary error function The complementary error function erfc is defined by the following equation:

$$\begin{matrix}erfc ( x ) = 1 - erf ( x ) \\ = \frac{2}{\sqrt{π}} {\int }_{x}^{∞} {e}^{- {t}^{2}} dt = {e}^{- {x}^{2}} erfc x ( x )\end{matrix} \qquad [ Formula 1 ]$$

In the evaluation employed in the present specification, the fitting parameter was optimized by minimizing a residual sum of squares of raw data obtained and the above function. Individual items were set by designation or selection in the following manner: measurement processing condition was single shot; measurement region processing adjustment item was edge method in the surface; internal surface edge was 6.0 μm; internal left-right edge was automatic; internal deep portion edge was automatic (center of sample film thickness); and elongation of phase curve to center of sample thickness was fitting curve.

At the same time, distributions of the concentrations of alkali metal ions (sodium ions and potassium ions) in a direction of a cross section were measured using an electron probe micro analyzer (EPMA). It was confirmed that there were no discrepancies between the stress profile obtained above and a result of this measurement.

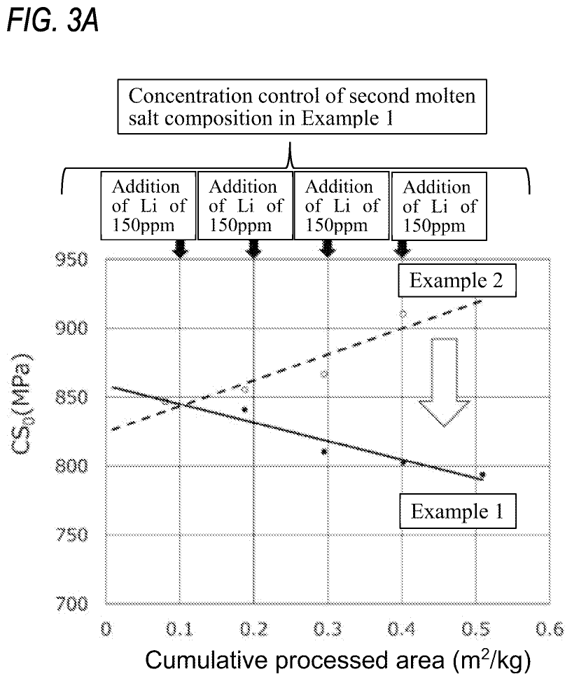

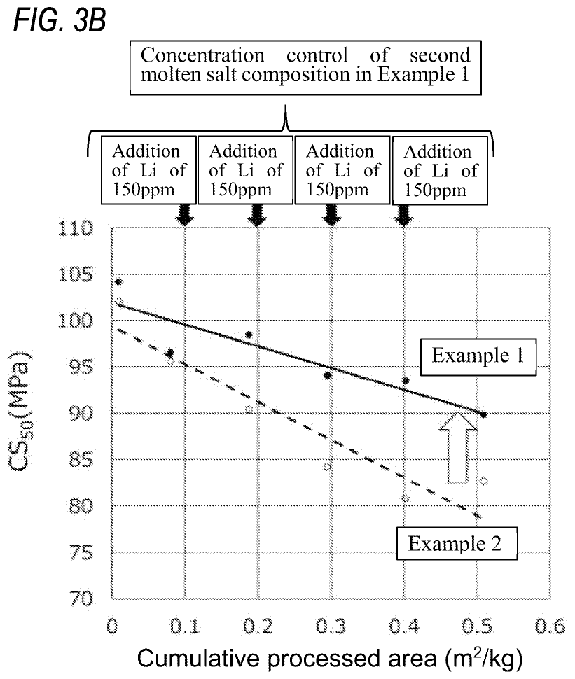

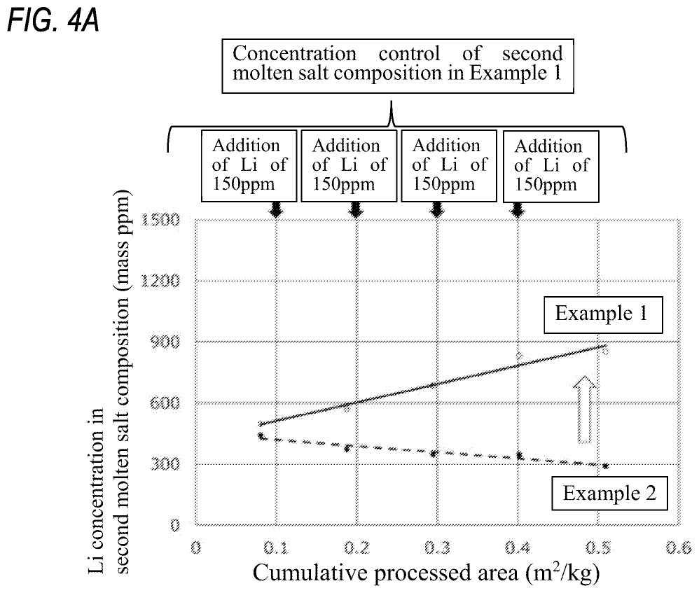

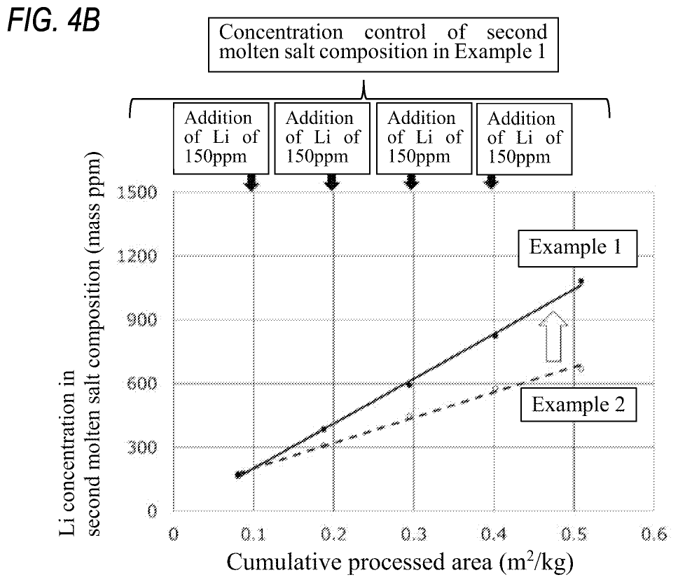

Results are shown in FIGS. 3A and 3B and FIGS. 4A and 4B.

FIG. 3A is a graph showing a correlation between the cumulative processed area of chemically strengthened glass obtained after the first ion exchange processed using the second molten salt composition and CS₀ of the chemically strengthened glass manufactured. As shown in FIG. 3A, in Example 2 that does not include a process of controlling the concentration of the second molten salt composition, CS₀ of the chemically strengthened glass manufactured increased as the cumulative processed area of the chemically strengthened glass obtained after the first ion exchange processed using the second molten salt composition increases. On the other hand, in Example 1 that includes the process of controlling the concentration of the second molten salt composition, CS₀ of the chemically strengthened glass manufactured decreased gradually.

FIG. 3B is a graph showing a correlation between the cumulative processed area of the chemically strengthened glass obtained after the first ion exchange processed using second molten salt composition and CS₅₀ of the chemically strengthened glass manufactured. As shown in FIG. 3B, in Example 2 that does not include a process of controlling the concentration of the second molten salt composition, CS₅₀ of the chemically strengthened glass manufactured decreased gradually as the cumulative processed area of the chemically strengthened glass obtained after the first ion exchange processed using the second molten salt composition increases. On the other hand, in Example 1 that includes the process of controlling the concentration of the second molten salt composition, CS₅₀ of the chemically strengthened glass manufactured decreased more gently than in Example 2.

It has been found from the results shown in FIGS. 3A and 3B that where the second molten salt composition is used continuously while first alkali metal ions are added to it, although CS (CS₀) of a surface layer of the chemically strengthened glass manufactured tends to decrease, the decrease of CS₅₀ which is the compressive stress in the vicinity of the glass surface is gentler than in the case that the second molten salt composition is used continuously without adding first alkali metal ions to it.

FIG. 4A is a graph showing a correlation between the cumulative processed area of the chemically strengthened glass obtained after the first ion exchange processed using the second molten salt composition and the Li concentration in the second molten salt composition. As shown in FIG. 4A, in Example 2 which is a Comparative Example, the Li concentration in the second molten salt composition decreased gradually as the cumulative processed area of the chemically strengthened glass obtained after the first ion exchange processed using the second molten salt composition increase. On the other hand, in Example 1 which is an Inventive Example, the Li concentration in the second molten salt composition increased gradually.

FIG. 4B is a graph showing a correlation between the cumulative processed area of the chemically strengthened glass obtained after the first ion exchange processed using the second molten salt composition and the Na concentration in the second molten salt composition. As shown in FIG. 4B, in Example 1 which is an Inventive Example, the rate of increase of the Na concentration in the second molten salt composition was higher than that in Example 2 which is a Comparative Example. This indicates that the amount of exchange between sodium ions in the chemically strengthened glass obtained after the first ion exchange and lithium ions in the second molten salt composition increased.

It has been found from the results shown in FIGS. 4A and 4B that in the case where the second molten salt composition is used continuously while first alkali metal ions are added to it, the amount of exchange between sodium ions in the chemically strengthened glass obtained after the first ion exchange and lithium ions in the second molten salt composition can be made larger than in the case that the second molten salt composition is used continuously without adding first alkali metal ions to it.

The present application is based on Japanese Patent Application No. 2021-030727 filed on Feb. 26, 2021, and the contents thereof are incorporated herein by reference.

What is claimed is:

1. A manufacturing method for a chemically strengthened glass, the method comprising:
performing a first ion exchange by immersing a glass for chemical strengthening containing first alkali metal ions in a first molten salt composition containing second alkali metal ions having a larger ion radius than the first alkali metal ions;
performing a second ion exchange, after the first ion exchange, by immersing the chemically strengthened glass obtained after the first ion exchange in a second molten salt composition containing the first metal ions and third alkali metal ions having a larger ion radius than the second alkali metal ions;
continuously using the first molten salt composition after being used for the first ion exchange for a next first ion exchange; and
continuously using the second molten salt composition after being used for the second ion exchange for a next second ion exchange,
wherein:
a concentration of the second molten salt composition is controlled by adding the first alkali metal ions to the second molten salt composition after being used for the second ion exchange to continuously use a resulting second molten salt composition for the next second ion exchange.

2. The manufacturing method for a chemically strengthened glass according to claim 1, wherein the concentration of the second molten salt composition is controlled by adding the first alkali metal ions to the second molten salt composition so that a concentration of the first alkali metal ions in the second molten salt composition becomes 100 mass ppm or higher.

3. The manufacturing method for a chemically strengthened glass according to claim 1, wherein the concentration of the second molten salt composition is controlled by adding the first alkali metal ions to the second molten salt composition so that an evaluation value of CS₅₀ becomes 70% or larger with respect to an initial value of CS₅₀ regarded as 100%,
the initial value of CS₅₀ being a compressive stress value in MPa at a depth 50 μm from a surface of a chemically strengthened glass manufactured by the first ion exchange and the second ion exchange that uses the second molten salt composition that has been used for no second ion exchange; and
the evaluation value of CS₅₀ being a compressive stress value in MPa at a depth 50 μm from a surface of the chemically strengthened glass manufactured by the first ion exchange and the second ion exchange that uses the continuous-use second molten salt composition that has been used for preceding second ion exchange.

4. The manufacturing method for a chemically strengthened glass according to claim 1, wherein the concentration of the second molten salt composition is controlled by adding the first alkali metal ions to the second molten salt composition so that an evaluation value of CS₉₀ becomes 70% or larger with respect to an initial value of CS₉₀ regarded as 100%,
the initial value of CS₉₀ being a compressive stress value in MPa at a depth 90 μm from a surface of a chemically strengthened glass manufactured by the first ion exchange and the second ion exchange that uses the second molten salt composition that has been used for no second ion exchange; and
the evaluation value of CS₉₀ being a compressive stress value in MPa at a depth 90 μm from a surface of the chemically strengthened glass manufactured by the first ion exchange and the second ion exchange that uses the continuous-use second molten salt composition that has been used for preceding second ion exchange.

5. The manufacturing method for a chemically strengthened glass according to claim 1, wherein the concentration of the second molten salt composition is controlled by adding the first alkali metal ions to the second molten salt composition so that a compressive stress value CS₀ at a surface of the chemically strengthened glass manufactured becomes 700 MPa or larger.

6. The manufacturing method for a chemically strengthened glass according to claim 1, wherein:
the first alkali metal ions are lithium ions;
the second alkali metal ions are sodium ions; and
the third alkali metal ion are potassium ions.

7. The manufacturing method for a chemically strengthened glass according to claim 6, wherein:
the first molten salt composition contains a sodium nitrate;
the second molten salt composition contains a lithium nitrate and a potassium nitrate;
a concentration of the potassium nitrate in the second molten salt composition is 85 mass % or higher; and
a mass ratio of (sodium ions)/(lithium ions) in the second molten salt composition is 0 or larger and 15 or smaller.

8. The manufacturing method for a chemically strengthened glass according to claim 6, wherein:
the first molten salt composition contains a potassium nitrate and a sodium nitrate;
in the first molten salt composition, a concentration of the potassium nitrate is higher than a concentration of the sodium nitrate;
the second molten salt composition contains a lithium nitrate and a potassium nitrate;
a concentration of the potassium nitrate in the second molten salt composition is 85 mass % or higher; and
a mass ratio of (sodium ions)/(lithium ions) in the second molten salt composition is 0 or larger and 15 or smaller.

9. The manufacturing method for a chemically strengthened glass according to claim 8, wherein the concentration of potassium nitrate in the first molten salt composition is higher than 50 mass %.

10. The manufacturing method for a chemically strengthened glass according to claim 6, wherein:
the first molten salt composition contains a potassium nitrate and a sodium nitrate;
in the first molten salt composition, a concentration of the potassium nitrate is lower than a concentration of the sodium nitrate;
the second molten salt composition contains a lithium nitrate and a potassium nitrate;
a concentration of the potassium nitrate in the second molten salt composition is 85 mass % or higher; and
a mass ratio of (sodium ions)/(lithium ions) in the second molten salt composition is 0 or larger and 15 or smaller.

11. The manufacturing method for a chemically strengthened glass according to claim 7, wherein a concentration of the sodium nitrate in the second molten salt composition is more than 0 mass % and 5 mass % or lower.

12. The manufacturing method for a chemically strengthened glass according to claim 7, wherein a concentration of the lithium ions in the second molten salt composition is 100 mass ppm or higher and 10,000 mass ppm or lower.

13. The manufacturing method for a chemically strengthened glass according to claim 7, wherein the lithium nitrate is added to the second molten salt composition by 0.01 to 0.2 mass % every time a processed area 0.1 m²/kg is achieved.

14. The manufacturing method for a chemically strengthened glass according to claim 1, wherein in the first ion exchange the first molten salt composition has a temperature of 360° C. or higher and 450° C. or lower.

15. The manufacturing method for a chemically strengthened glass according to claim 14, wherein the glass for chemical strengthening is immersed in the first molten salt composition for 0.5 hour or longer and 12 hours or shorter.

16. The manufacturing method for a chemically strengthened glass according to claim 1, wherein in the second ion exchange the second molten salt composition has a temperature of 360° C. or higher and 450° C. or lower.

17. The manufacturing method for a chemically strengthened glass according to claim 16, wherein in the second ion exchange a time t2 (min) of immersion of the chemically strengthened glass obtained after the first ion exchange in the second molten salt composition satisfies the following inequality:
−0.38T+173<t2<−1.4T+720
where T (° C.) is the temperature of the second molten salt composition.

18. The manufacturing method for a chemically strengthened glass according to claim 1, wherein chemical strengthening is performed so that a maximum tensile stress value CT₂ (MPa) of the chemically strengthened glass obtained after the second ion exchange becomes 50% to 93% of a maximum tensile stress value CT₁ (MPa) of the chemically strengthened glass obtained after the first ion exchange.

19. The manufacturing method for a chemically strengthened glass according to claim 1, wherein a maximum tensile stress value CT₁ (MPa) of the chemically strengthened glass obtained after the first ion exchange satisfies the following inequality:
−CT₁>17.5/(t/2−DOL/1,000)
where t is a thickness (mm) of the chemically strengthened glass and DOL is a depth (μm) of a compressive stress layer.

20. The manufacturing method for a chemically strengthened glass according to claim 6, wherein the glass for chemical strengthening comprises, as represented by mol % based on oxides:
SiO₂ of 52% to 75%;
Al₂O₃ of 8% to 20%; and
Li₂O of 5% to 16%.

21. The manufacturing method for a chemically strengthened glass according to claim 1, wherein the second molten salt composition contains a silicic acid.

22. The manufacturing method for a chemically strengthened glass according to claim 1, wherein the second molten salt composition contains a carbonate salt.
